(19) United States
(12) Patent Application Publication
(10) Pub. No.: US 2007/0266003 A1
(43) Pub. Date: Nov. 15, 2007

(54) METHOD AND SYSTEM FOR CONSTRUCTING DYNAMIC AND INTERACIVE FAMILY TREES BASED UPON AN ONLINE SOCIAL NETWORK

(75) Inventors: June T. W. Wong, Vancouver (CA); Clement K.L. Ma, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: 0752004 B.C. Ltd., Vancouver (CA)

(21) Appl. No.: 11/382,430

(22) Filed: May 9, 2006

(51) Int. Cl. G06F 17/30

(52) U.S. Cl. 707/3

(57) ABSTRACT

A method of constructing family trees wherein users access a web site of an online social network and interactively contribute information to the family tree. The ability of the user to add or edit the information in that user's family tree depends on whether the user is active within the system.

### TECHNICAL FIELD

The invention relates to the field of genealogy and more particularly to the construction of family trees and social networks.

### BACKGROUND

Genealogy, the study of family ancestries and lineage, has become one of the most popular modern hobbies. It involves the investigation of family relationships among living and deceased persons in order to establish family trees, and in some cases detailed family histories. A “family tree” is a depiction of the relationships between family members, living and deceased.

Many families attempt to carry out their own genealogical investigations, but prior to the present invention it has been difficult to recruit family members to jointly and interactively construct, expand, share and save family trees. It is often difficult to get family members involved in the process of gathering information, preserving information and records, and constructing and updating the family tree. When older generations die, interest may be lost in maintaining the family information and records due to a lack of a systematic way for all family members to preserve records, and lack of easy accessibility to the family tree. As a result, important information and records can be lost with each generation. While a few family members may be active in constructing the family tree, most will find it difficult to take the time to be involved or contribute information to the family tree or even learn of its existence. Furthermore, family members from distant branches of the same family tree may not be able to effectively communicate or share information. It is difficult even for the actively interested family members to obtain and compile updated information from all branches of the tree in order to update the family tree as the various branches continue to change and expand over time. As a result, there is the risk that as families grow, entire branches may eventually be lost or cut off from the tree. Furthermore, there is a lack of an effective method to systematically distribute records to all family members in all branches of the family tree or to make records systematically accessible to family members in all branches of the family tree. Thus, records and investigations which have been made may not be effectively distributed to all branches of the family tree in future generations and distant family members may never learn of or contribute to the investigations that have been made. Once constructed, it is difficult to share the family tree with all family members or recruit new family members to add to it. There is therefore a need for a method of jointly and interactively constructing, expanding sharing and saving family trees in a more dynamic fashion to optimize participation, communication, sharing, recruitment and growth.

More recently, computer software programs such as Family Tree Maker™ marketed by Ancestry.com and Genealogy.com have been used to facilitate the construction and display of family trees. The structure of such family trees generated by such programs are not based upon a social network. Social networking systems such as Myspace.com and Friendster.com do not permit linkages to deceased individuals and are not based on familial linkages. Such systems have not previously been used to construct family trees.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The invention provides a method of constructing a family tree whereby individual nodes in the family tree are linked as an online social network, wherein a plurality of users are accessible to the online social network, the method comprising: i) providing a system comprising a website and database, the system maintained by a server accessible online to the plurality of users; ii) creating a plurality of nodes, each node representing a living or deceased member of the family tree, each node representing a member of the family tree who has registered with the system or who has not registered with the system, each node linked by one or more linkages to one or more additional nodes in the family tree, each linkage defined by one or more linkage types, the linkage type representing the relationship type which exists between the individuals represented by each node; and iii) permitting the living members of the family tree to access and modify the family tree via the online social network.

According to one aspect of the invention, the nodes for the members who have registered with the system may be designated as active, and nodes of other living members who have not registered with the system as well as deceased members may be designated as inactive. Members represented by active nodes can edit or add to the family tree and invite living individuals represented by inactive nodes in the family tree to register and to become active.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a schematic diagram illustrating a computer network as used in the invention;

FIG. 2 is a flowchart illustrating one aspect of the invention involving creation of the family tree;

FIG. 3 through 9 are diagrams illustrating web pages representative of those that may be used in the invention.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

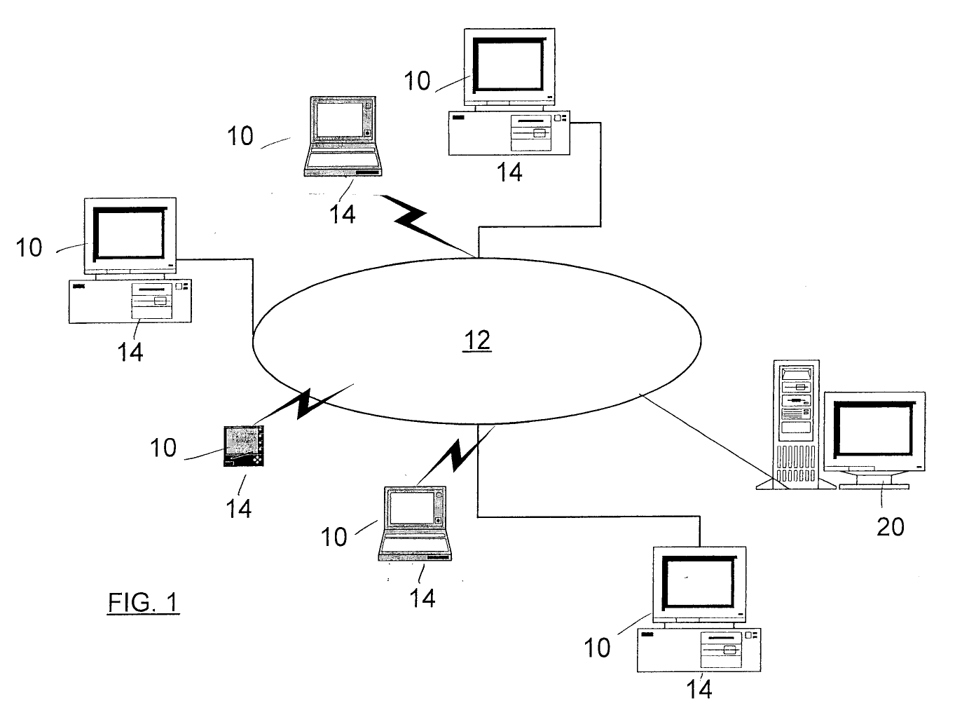

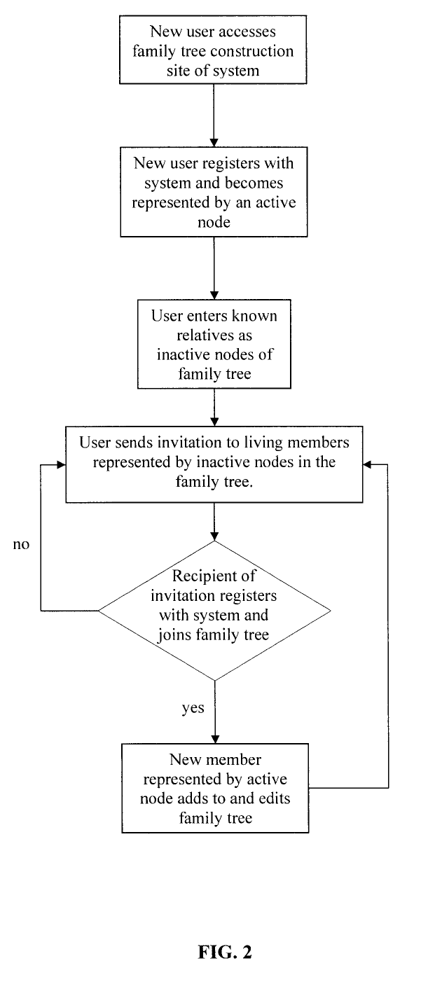

With reference to FIG. 1, a number of users 10 having computer terminals 14, whether laptops, desktops, handheld, personal digital assistants, mobile telephones or the like, have access to a computer network 12 such as the Internet, whether wirelessly or through wired access. A web server or servers 20 maintain a system comprising an Internet website, database and associated data, which is accessible to users 10.

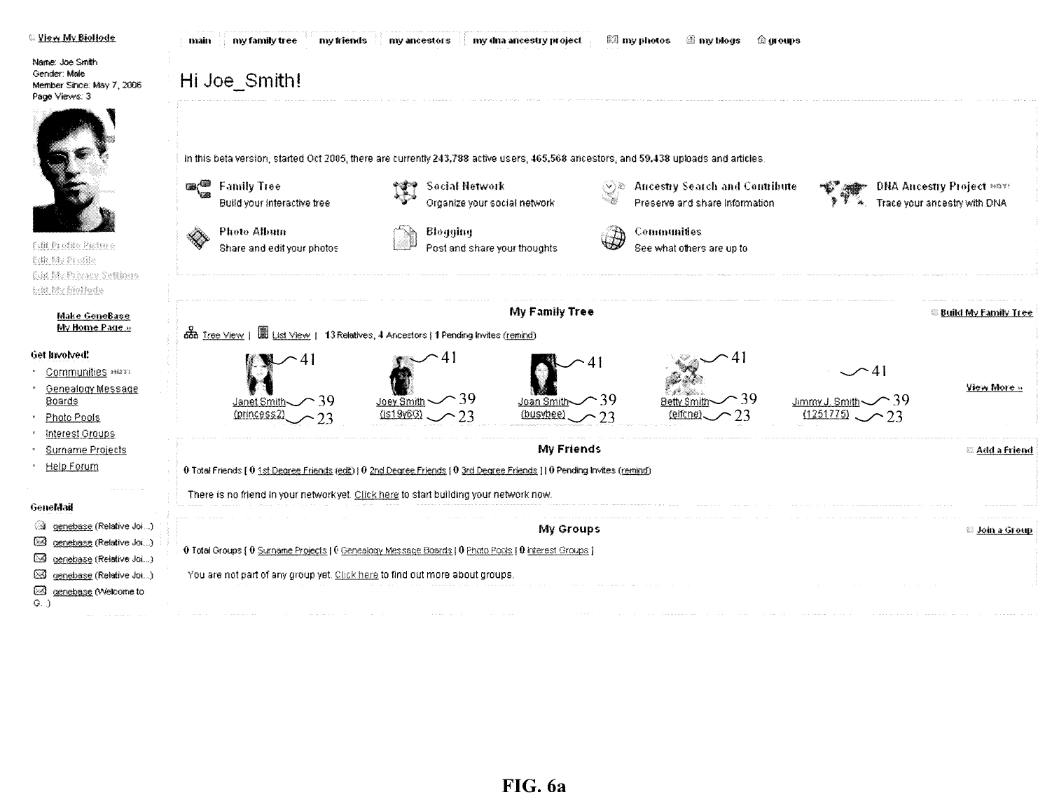

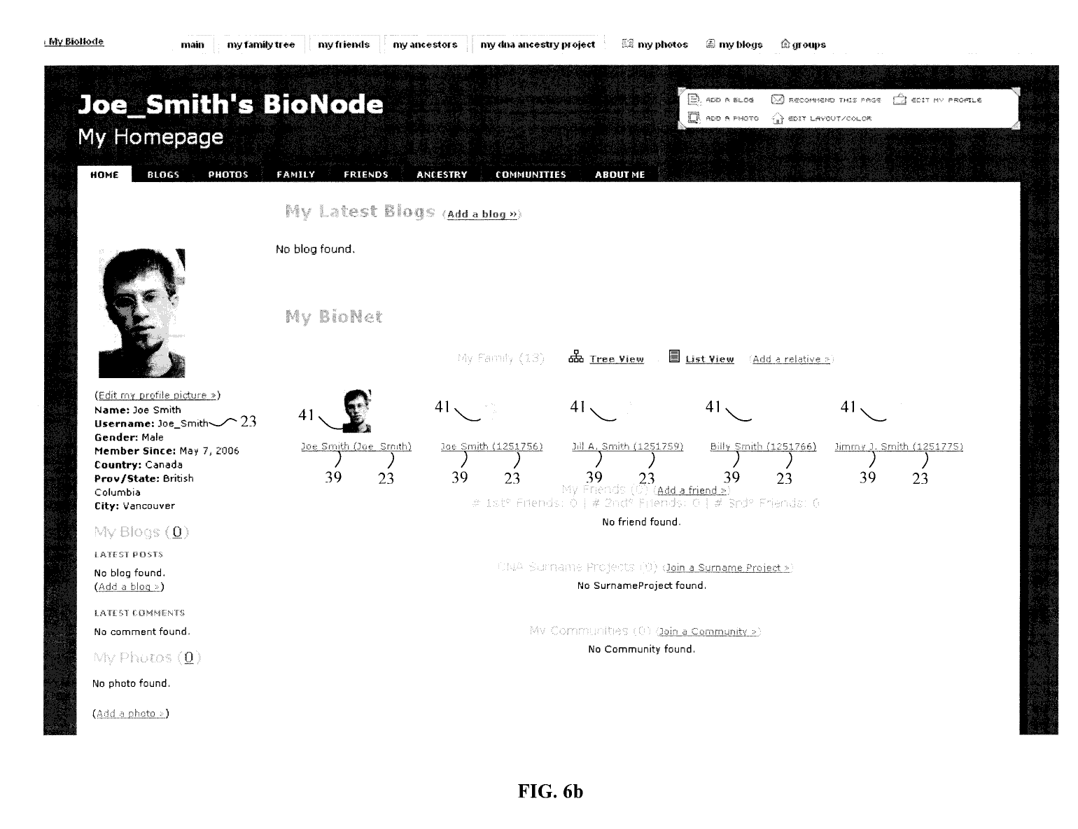

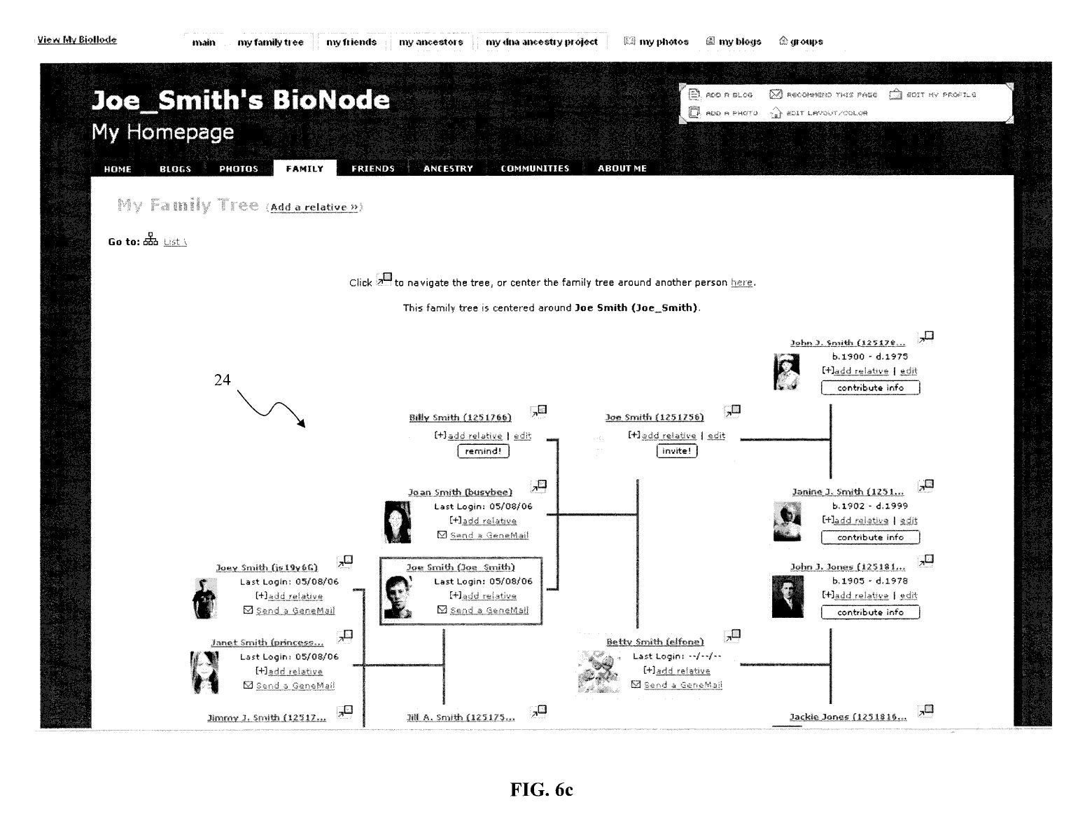

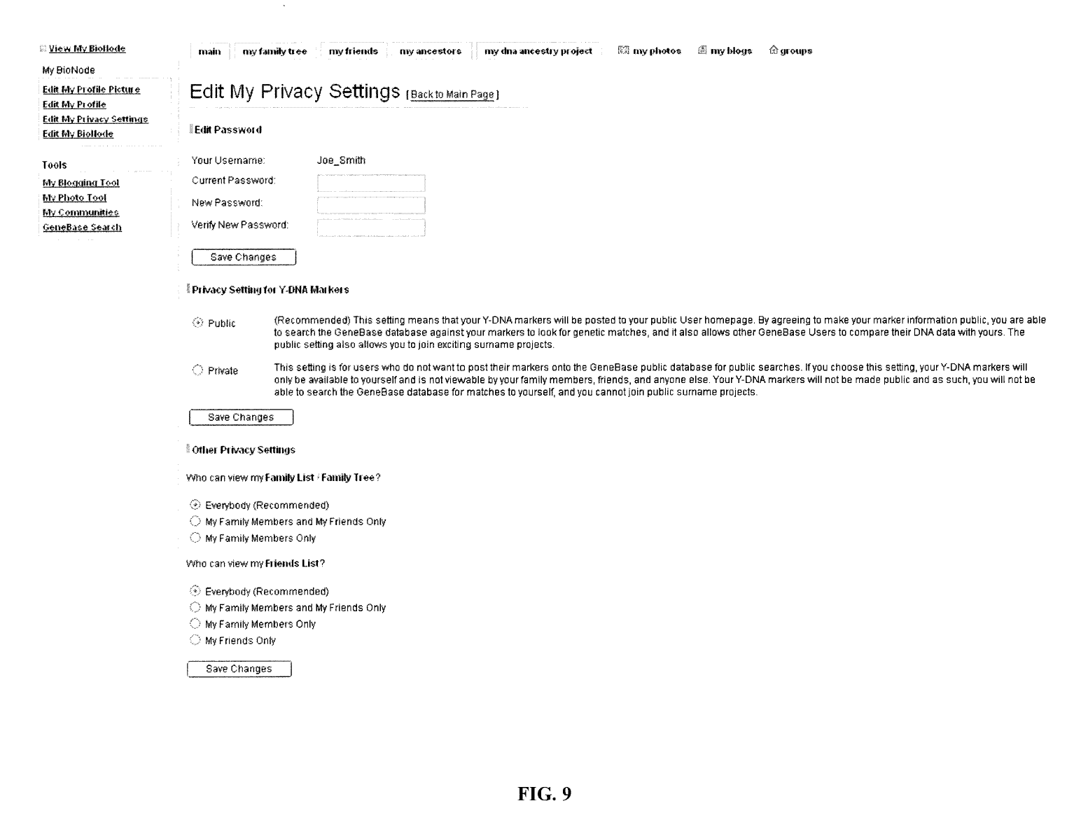

Initially user 10 accesses the system website and is presented with a page to register for the system by entering basic profile information, such as name, gender, address, birthdate and a username and password. A unique identifier 23, such as a number, alphanumeric or alphabetic string, is assigned to the user and, once registered, a representation in the system, hereinafter referred to as a “node” 30, is created for the user as part of the family tree. Such node is designated “living-active” as defined below. All of the foregoing are carried out in a manner well known to web site programmers. The user can upon registration and thereafter, carry out a number of tasks or activities while at the “control panel” (FIG. 6A) of his/her node, such as editing the user's own node including editing the content of the user's profile, the appearance of the node, selecting the layout and color of the user's node, adding, removing or editing photos, adding or changing privacy settings (FIG. 9), adding a blog or testimonials, joining groups, organizing memberships, sending emails from the node, and the like and in particular take advantage of the activities facilitated by the social networking features of the family tree, such as using certain communication tools. From the user's control panel (see FIG. 6A), individuals can build their family tree by adding nodes, each node in the family tree representing a relative in the family tree, edit the family tree, communicate with other nodes in the same family tree as well as other nodes outside the family tree, send invitations, accept invitations, grant permissions, share information, and take part in social network features with other nodes in the family tree. The node can be viewed by the user or third parties as a web page (see FIG. 6B) having features designed by the user it represents.

Alternatively a user may first construct a family tree by uploading one or more members of a family tree from a suitable file, such as a GEDCOM file, which file forms the initial family tree to be expanded or edited by members of the system.

Creating a Family Tree

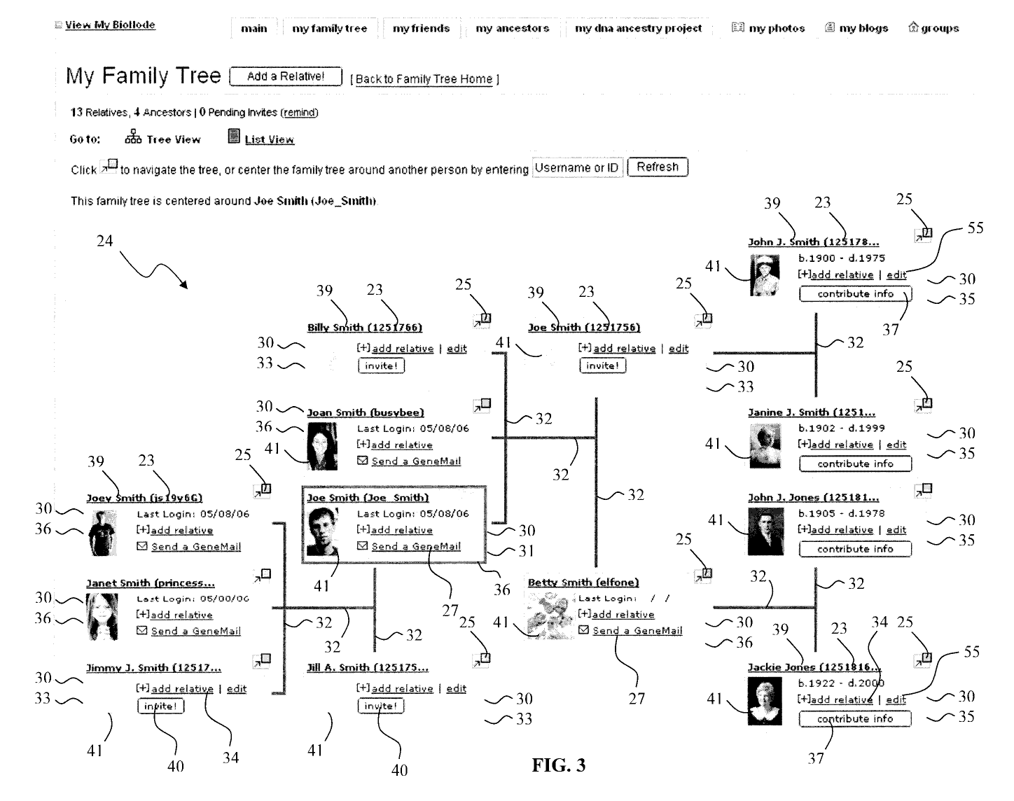

Once registered, a user may start construction of his/her family tree 24 (FIG. 3). The family tree is represented by a number of elements, each representing a living or deceased individual, which are referred to as “nodes” 30, joined by connections 32, referred to as “linkages”, to other nodes. “Linkage” refers to the direct link between two adjacent nodes or the chain of links and nodes between non-adjacent nodes. The user, whose node 31 is the first node in the tree, can expand the tree by adding nodes 30 representing relatives, for example by clicking on a link 34 and entering information concerning his/her relatives and ancestors, such as parents, grandparents, spouse and children, and whether they are living or deceased. Each time a relative is added, that relative is assigned a unique identifier 23 and a node 30 in the family tree, the nodes in the family tree thereby forming a social network.

Alternatively, a family tree can be created or contributed by a user who is not a member of that family tree, or by a user who is not registered with the system.

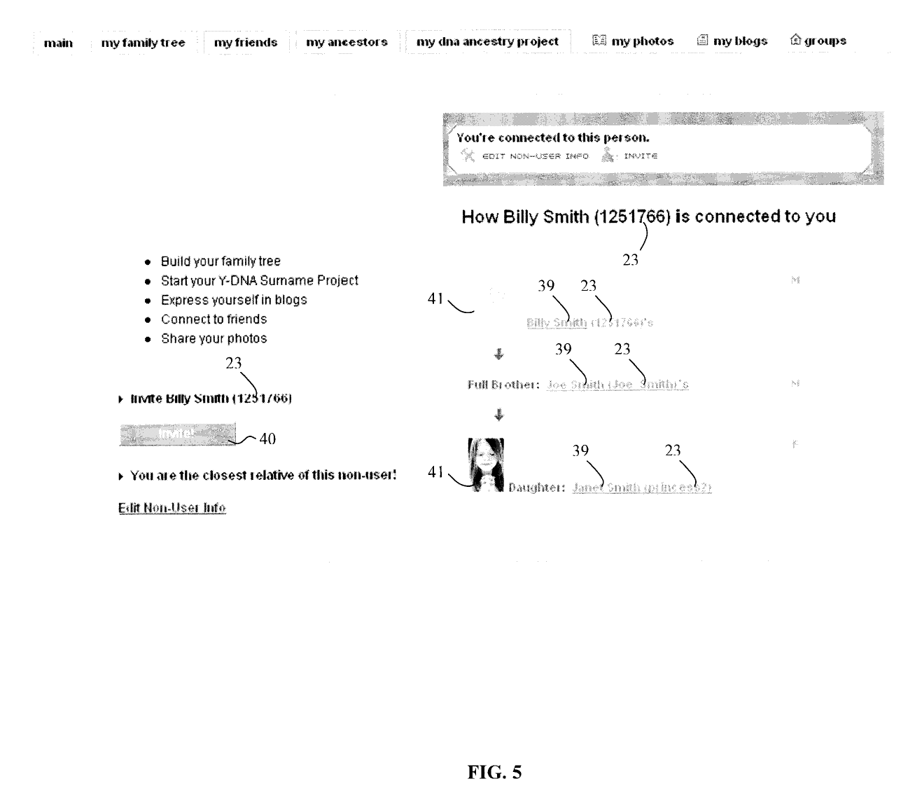

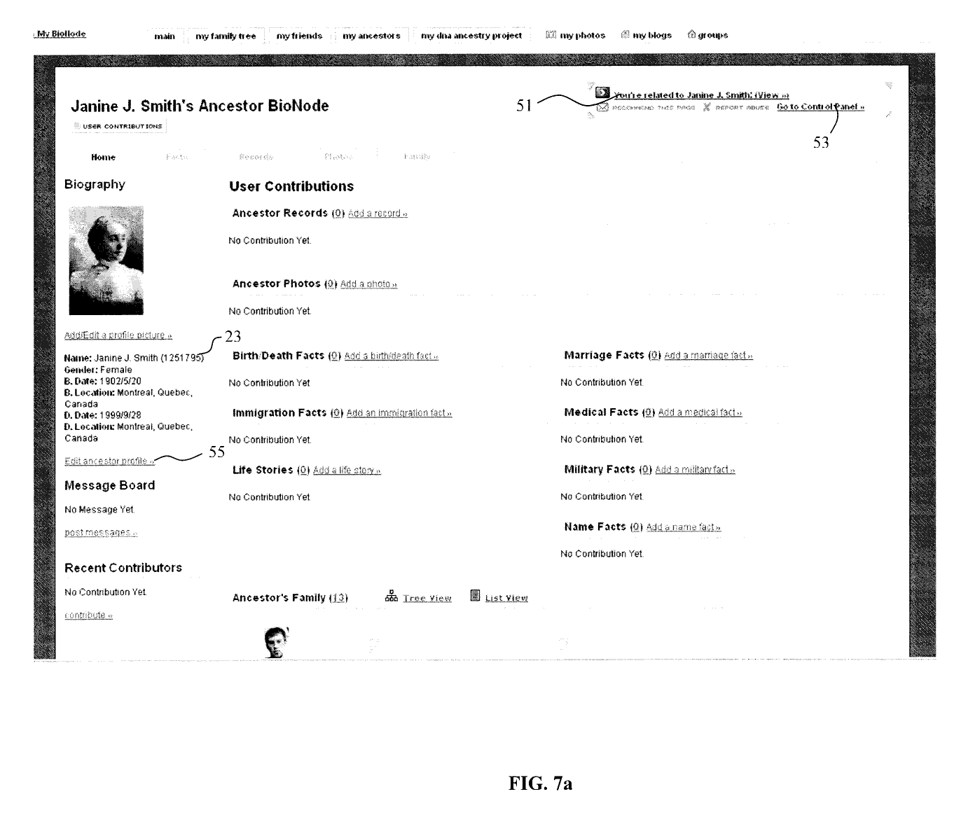

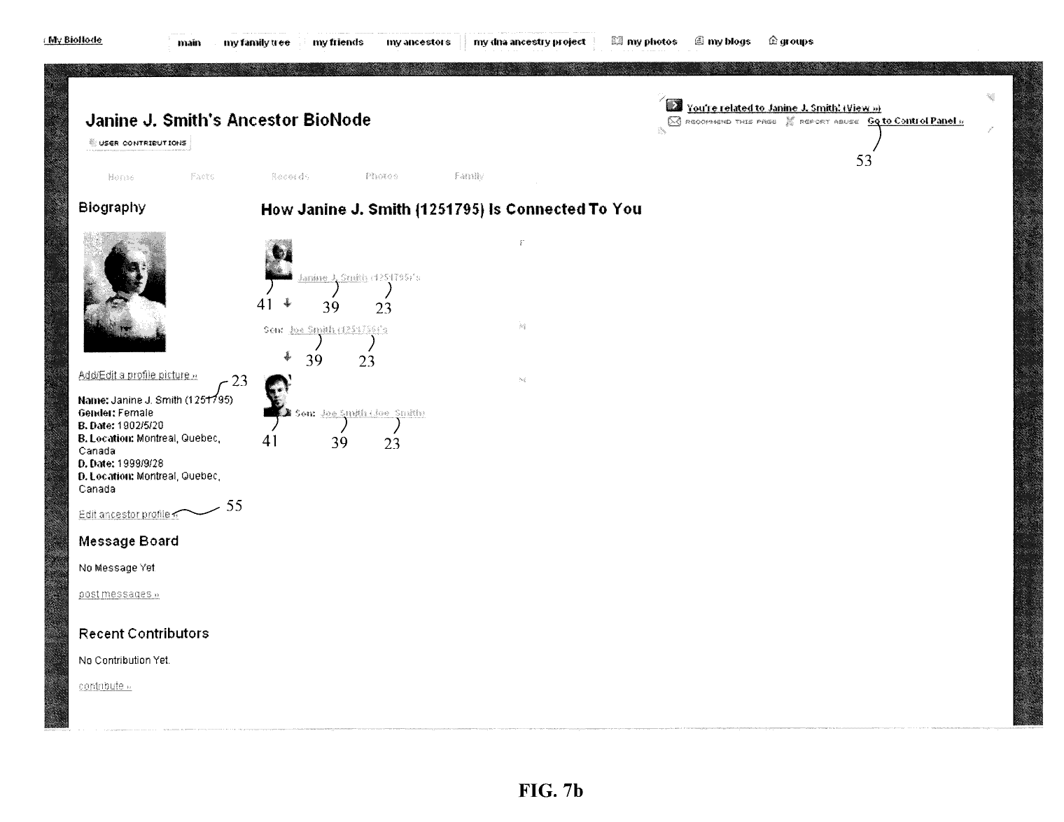

Nodes represent individuals who are either living or deceased, and the user may so designate a particular node as representing a living or deceased individual. Users who have registered with the system are “active” while individuals whose nodes form part of a family tree but have not registered with the system are “inactive”. A “living-active” node 36 is one whose associated user has registered with the system, and who is alive. It contains the home page (FIG. 6B) and information pertaining to user represented by the node, as well as a control panel (FIG. 6A) accessible to the living individual that it represents. Individuals who are not registered with the system are either designated as “living-inactive” 33 or “deceased-inactive” 35 (FIG. 3). A “living-inactive” node is one whose associated user is alive but has not registered with the system, and a “deceased-inactive” node is one whose associated user is deceased. The effect of these designations is discussed further below. A living-inactive node 33 contains the data and tools associated with the living-inactive node, a control panel and all other associated features of the living-inactive node as shown in FIG. 5. A “deceased-inactive” node 35 contains an ancestor home page as described below (see FIG. 7A) and a control panel, FIG. 7C, for other living users to edit the ancestor node 35.

While a “deceased-inactive” node 35 will always remain so (unless the designation was made in error), a “living-inactive” node 33 becomes “living-active” once the living individual that it represents joins the system through registration as described further below. Either living-active or inactive nodes 36, 33 become deceased-inactive 35 when the associated individual that it represents dies. Thus individuals can be classified as living or deceased, and living individuals are classified as active (registered) or inactive (not registered). These designations affect how the information connected with the node can be modified, and how communications are made between nodes.

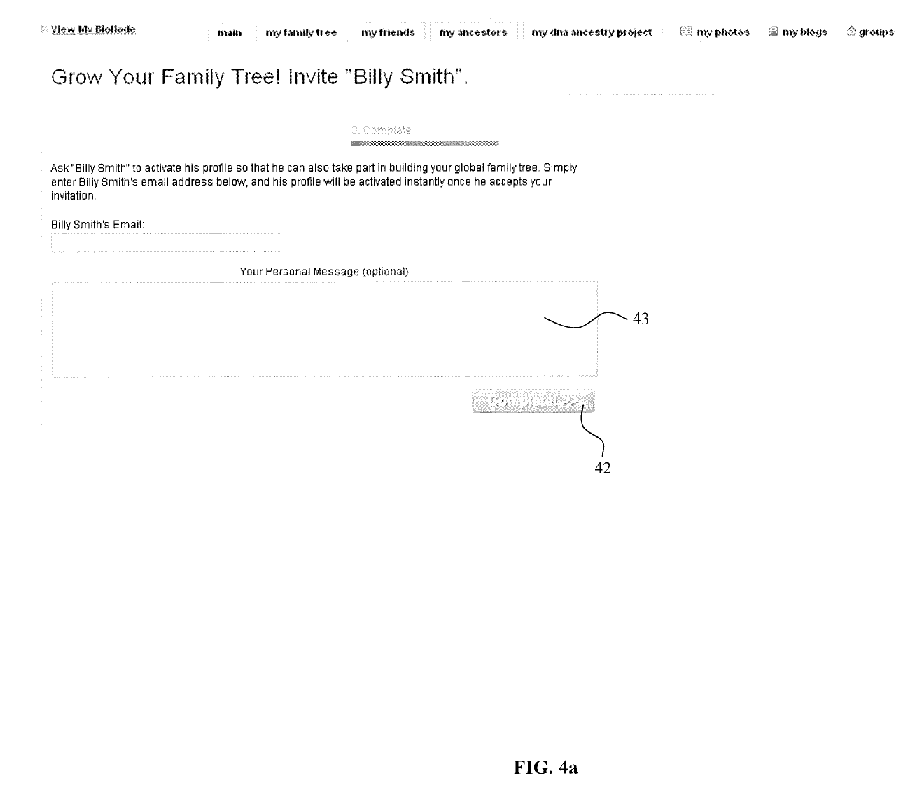

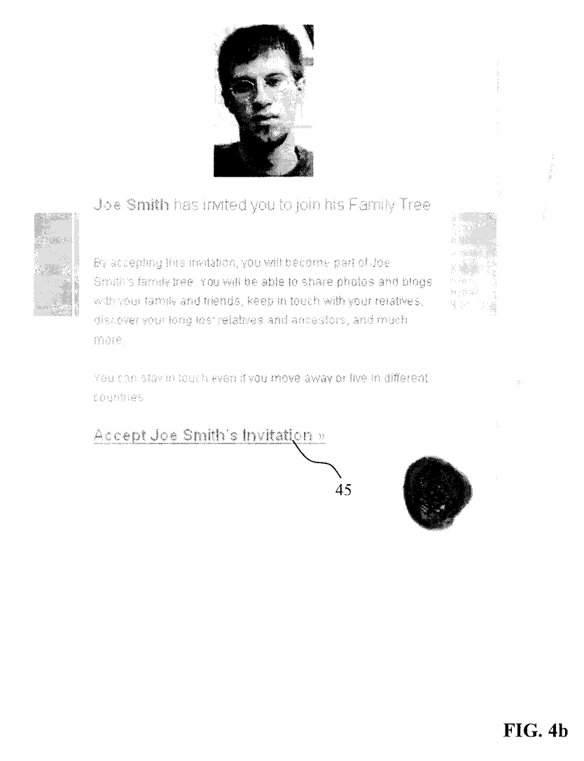

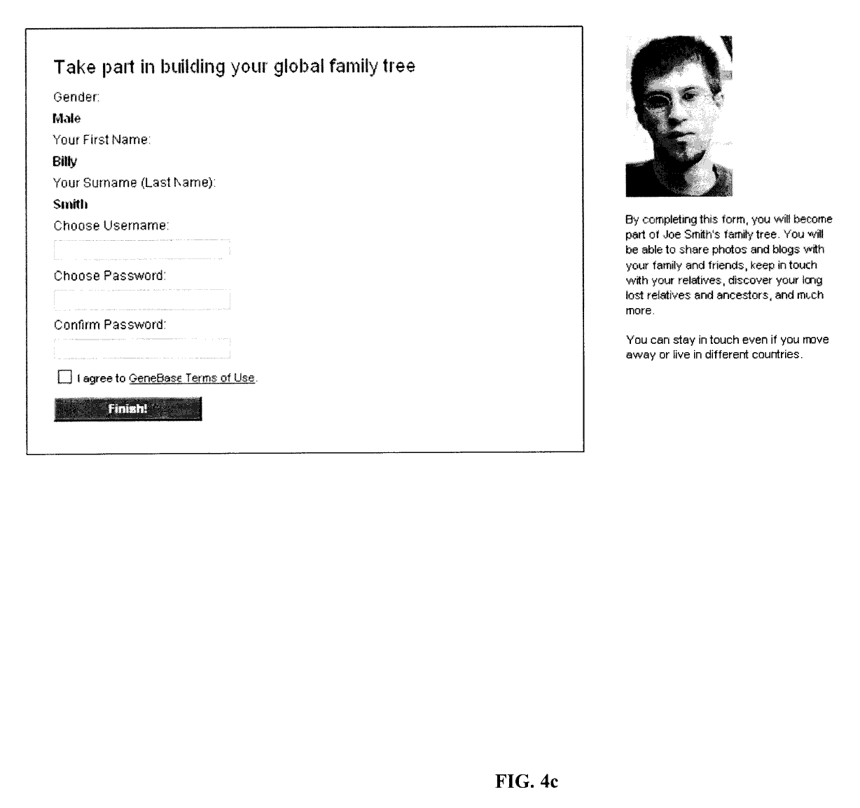

An individual with a living-active node 36 can identify individuals with living-inactive nodes 33 within the same family tree and send an invitation as shown in FIGS. 4a and 4b to the individual represented by a living-inactive node 33 to register with the system and become represented by a living-active node 36 in the family tree. For example, after a user creates a node for a relative in the family tree, the user may invite the new inactive entry (if living) to join the system. By clicking on a link 40 associated with the node of the individual in question, the user is taken to a page (FIG. 4a) which invites the user to enter the email address of the relative represented by an inactive node in the family tree and optionally include a personal message 43 (FIG. 4a). The user then clicks on a link 42 to send the message and the system composes and sends an email invitation (shown in FIG. 4b) to the email address provided. The recipient of the email may accept the invitation by clicking on a hyperlink 45 which takes the recipient to a page (shown in FIG. 4c) to enter the registration details and register the recipient in the system, at which point the node associated with the individual becomes designated as “living-active”. Of course, the inactive individual can also be invited to join the network by telephone, postal mail, verbally in person, by internal messaging systems, etc. The living-inactive node 33 may become active once the individual that it represents accesses the system and registers, or registers independently of any invitation.

Thus the system designates individual nodes 30 as living-active 36, living-inactive 33, or deceased-inactive 35. A living-active individual node is a node where the corresponding living individual that it represents has either registered with the system and created his/her node or accepted someone else's creation of a living-inactive node and registered with the system, thereby changing the node to living-active. Living individuals with a node in the family tree who have not registered are designated by living-inactive nodes 33. Deceased individuals, including ancestors, may exist as deceased-inactive nodes 35 in the family tree. Living individuals can represent themselves to other living individuals through their living-active nodes and interact electronically with other living individuals represented by a living-active node.

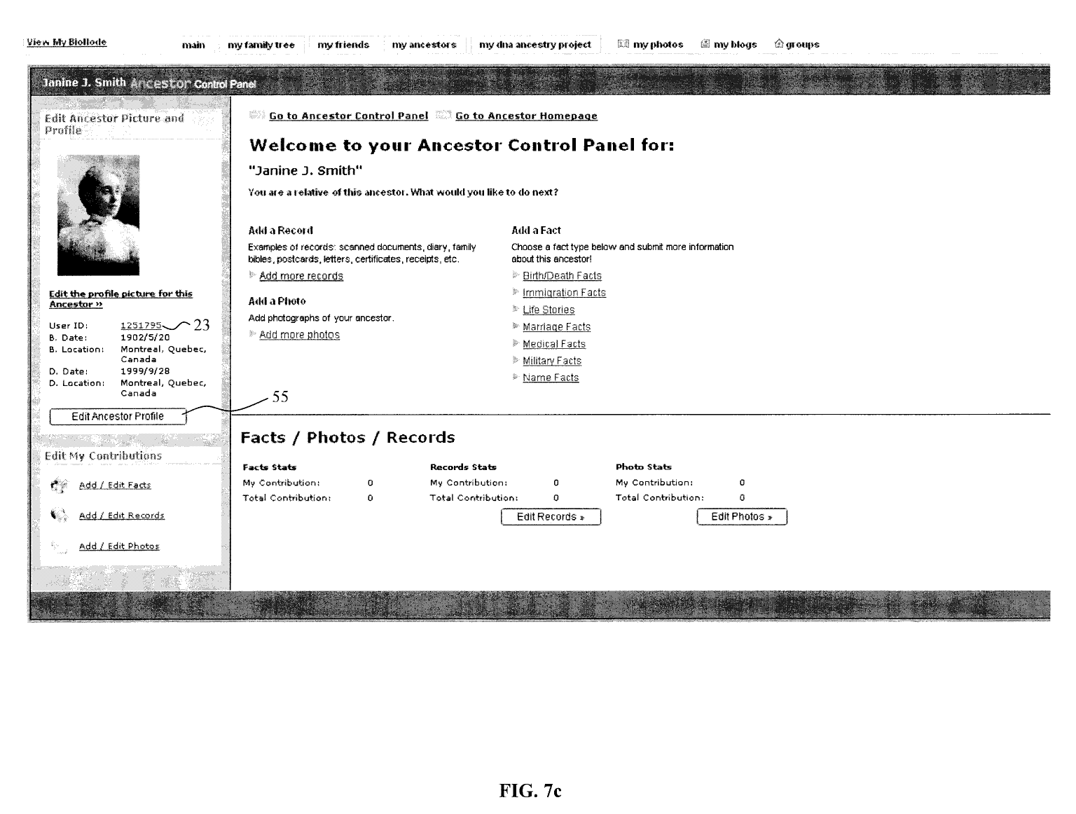

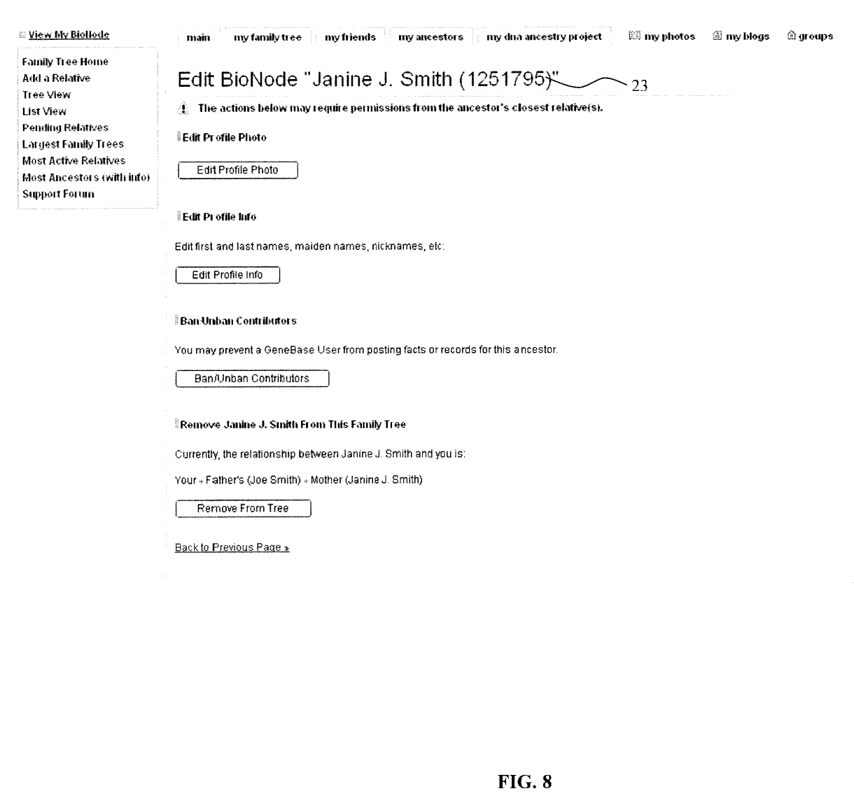

Once an individual's node becomes active, he/she can add to the family tree 24 by creating new nodes 30 for individuals that he/she would like to add to the family tree and linking the nodes to existing nodes in the family tree through defined familial relationships, thus growing the family tree. Individuals with active nodes 36 can edit the family tree by editing other inactive nodes 33, 35 (whether living or deceased, see FIG. 8) in the same tree, and can seek to expand the family tree by inviting individuals who are represented by a living-inactive node 33 within the family tree to join the family tree by registering and activating their corresponding node.

The family tree as shown in FIG. 3 is thus created by the addition and linkage of a node to one or more other additional nodes, or by uploading a file. The linkage can have one or more defined linkage types representing different relationship types, including familial (mother, father, spouse, sister, brother, child), biological, social (through adoption, god-parent relationship), genetic or other relationship. An individual's node may occupy more than one position in the same tree. For example an individual's node may be linked to the tree as both a sibling of one node and a spouse of another node in the same tree. The relationship of a node to another node within the same family tree can also be represented by one or more defined linkage types. For example an individual may be a spouse of another individual in the tree as well as related to the same individual through other relationship types. The relationship of a node to another node within the same family tree can be represented graphically by a series of linkages of nodes as shown in FIG. 3.

A living individual with a living-active node can view the connection, one or a series of defined linkages of nodes, between its own node and any other node in the family tree. The user can determine the linkage and view the connection between the user's node 31, 36 and another node 30, as shown in FIG. 5, by clicking on a hyperlink 39 or 41 in FIG. 3 or from a home page, FIG. 6B or FIG. 7A, such as by clicking on link 51, and from which the user can view a chain showing the precise connection between any two nodes (see FIG. 7B and FIG. 5). The family tree 24 can be viewed directly from the home page associated with the node (FIG. 6B and FIG. 6C) or from the control panel of the viewer (FIG. 3).

The family tree 24 can be viewed in many ways, such as graphically as a set of nodes 30 connected by their associated linkages 32, or as a list, or other types of views known to those in the field of genealogy. The family tree can be presented graphically by setting a single node as the root of the family tree and displaying a set number of linkages 32 radiating from the root node. Another part of the family tree can be viewed by resetting another node as the root. This can be done by entering that node's username or identification 23, or by clicking on a link 25 from the node of interest. When the family tree 24 is viewed from a node (see FIG. 6C) or its associated control panel (FIG. 3), the individual represented by the node or control panel is set as the original root. When a viewer navigates the family tree away from the original root, the path back to the original root is displayed. The family tree for any individual can be viewed by viewing the individual's node (see FIG. 6C).

Accessing Individual Information and Tools

Each living-active node can contain information pertaining to the living individual that it represents, communication tools, data and files, storage space, family tree and network information and tools to edit the family tree. Each living-active node allows the individual that it represents to log into the system and access its own node and its associated “control panel” (FIG. 6A). The control panel allows an individual to expand and edit the family tree by: adding nodes and linkages; editing nodes and linkages; inviting other individuals to join; communicating with other living individuals in the same family tree, other living individuals in the computerized network, as well as other living individuals outside the family tree; sending invitations; accepting invitations; granting permissions; sharing information; and taking part in the social networking features of the family tree.

A deceased-inactive node 35 can contain information pertaining to the deceased individual that it represents, home page (FIG. 7A), communication tools, data and files, storage space, family tree and network information, and tools to allow one or more living individuals to view, add, edit, or delete information pertaining to the deceased individual that it represents, such as by clicking on link 37 which takes the individual to a control panel as shown in FIG. 7C. The control panel of the deceased-inactive node (FIG. 7C) allows one or more living individuals to independently add, edit, or delete information for the same deceased-inactive node, such as by clicking on link 55 in FIG. 7C to go to a page as shown in FIG. 8. The control panel can also be accessed through link 53 on the ancestor home page (FIG. 7A). The identity of the contributor is automatically recorded. All contributions and contributors to the same deceased individual can be viewed from the deceased-inactive individual node 35. The deceased-inactive node 35 can also contain communication tools which allow living individuals to exchange information pertaining to the deceased individual that it represents.

Living-inactive nodes 33 can contain information pertaining to the living individual that it represents, home page (see FIG. 5) communication tools, data and files, storage space, family tree and network information, and tools to allow one or more living individuals to view, add, edit, or delete information pertaining to the individual that it represents. The living-inactive node can also contain invitation tools which allow other individuals to invite the individual represented by the living-inactive node to register with the system and thereby change the living-inactive node to living-active.

Editing the Family Tree

The family tree can be edited by living individuals who are represented by living-active nodes 36 within the same family tree or another family tree in the network. A deceased-inactive node 35 can be edited by one or more living individuals who are represented by a living-active node 36. For example, nodes can be edited by editing the facts, records, life story or other information about the individual, or altering whether they are living or deceased, or by leaving a testimonial, adding photos or other information. A living-inactive node 33 can also be edited by one or more living individuals who are represented by a living-active node 36. A living-active node 36 can be edited by the same living individual represented by the node. The living-active node can also be edited by one or more other living individuals who are represented by another living-active node 36, such as by leaving a testimonial, adding photos or other feedback, provided permission is obtained as described below.

The family tree can also be edited also by adding new nodes to the family tree 24, and by adding or modifying a series of linkages 32 between the existing nodes in the family tree 24. The family tree can be edited by changing the linkage type of an existing linkage in the family tree or by deleting a linkage. The permission for a living individual who is represented by a living-active node 36 to add a new node to the family tree can be defined by living individuals in the family tree who will be affected by the addition. The permission for a living individual who is represented by a living-active node to edit a linkage 32 in the family tree 24 can be defined by living individuals who will be affected by the edit. The family tree 24 can also be edited by adding new data to a node 30 within the family tree, such as by changing or deleting existing data connected with the node, or by changing the node type. For example, a “living-active” designation for a node 36 can be converted to a “living-inactive” designation 33. A “living-active” designation for a node 36 can also be converted to a “deceased-inactive” designation 35, once the individual that it represents becomes deceased. A “living-inactive” designation for a node 33 can also be converted to a “deceased-inactive” designation 35 once the individual that it represents becomes deceased. A deceased-inactive designation for a node 35 can also be converted to a “living-inactive” designation 33 to make a correction, and a “living-inactive” designation for a node 33 can also be converted to a “living-active” designation 36 as discussed below.

The permission for an individual with a living-active node to edit another node within the same family tree is defined by the individual relationship of the editing node to the node to be edited as well as the individual's relationship to all other individuals with an living-active node within the same family tree. An individual with a living-active node 36 can seek to enlarge the family tree by sending an invitation 40 to individuals with living-inactive nodes 33 within the family tree to join the family tree and change their living-inactive status into living-active status. The invited living individual can then join the family tree by accepting the invitation. A living individual can also join a family tree by registering with the system and become represented as a living-active node within the family tree.

Separate family trees can be merged into one. An individual with a living-active node can invite individuals with a living-active node from another family tree to join the family tree and merge the two family trees into one. Also, an individual with a living-active node can edit the family tree by adding an existing deceased-inactive node or a living-inactive node from another family tree and thereby merge the family trees into one. When two family trees both include nodes representing the same individual, an overlap is detected and a series of questions will be put to the user seeking to add the individual's node to his/her family tree in order to confirm the overlap. If the node is found to overlap two trees, then permissions will be sought to merge the two trees. Permission to edit the family tree by merging with another family tree is required from living individuals who are represented by living-active nodes in both family trees who will be affected by the merge. In a situation where nodes from separate family trees occupy the same position in the merged tree, an analysis in the form of a set of questions will be asked to determine whether the two nodes represent the same individual. If they do represent the same individual, then the separate nodes will be merged into one and the associated data will also be merged.

Communication Between Nodes

The interaction of an individual who is represented by a living-active node within a family tree with another individual who is represented by a living-active node within the same or another family tree is facilitated by the social networking features of the family tree. The social networking features of the family tree facilitate many forms of communication, such as notification of updates, alerts, sharing of files and photos, blogs, instant messaging and comments. Also, the sender can select those in the family tree who can receive or view a particular communication or file. An electronic message can be sent by regular email or by clicking on hyperlink 27 which takes the user to a page which permits an electronic message to be composed to be addressed to the addressee's username. The interaction can be direct communication between individuals, sharing of data, receiving data, editing data, notification of data updates within a node, transfer of data to another node, and addition of data to another node.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method of constructing a family tree whereby individual nodes in the family tree are linked as an online social network, wherein a plurality of users are accessible to the online social network, the method comprising:
i) providing a system comprising a website and database, said system maintained by a server accessible online to said plurality of users;
ii) creating a plurality of nodes, each node representing a living or deceased member of the family tree, each node representing a member of the family tree who has registered with the system or who has not registered with the system, each said node linked by one or more linkages to one or more additional nodes in the family tree, each linkage defined by one or more linkage types, the linkage type representing the relationship type which exists between the individuals represented by each said node; and
iii) permitting the living members of the family tree to access and modify said family tree via said online social network.

2. The method of claim 1 wherein the family tree is created by the linkage of a node to one or more additional nodes as a social network, each linkage having one or more than one defined linkage types.

3. The method of claim 1 wherein one of said users registers with the system and is assigned a first node with a unique identification; and comprising the further step of permitting said first user to create a plurality of additional nodes, each representing a living or deceased member of a family tree, each said node linked to said first node or said additional nodes by familial relationship, and comprising the further step of inviting one or more of said living members of the family tree to register with the system and continue to edit the family tree, including creating a plurality of additional nodes and continue to invite living members of the family tree to register with the system.

4. The method of claim 1 wherein each said node is adapted to be designated as living or deceased, wherein a living node represents a living individual in the family tree and a deceased node represents a deceased individual in the family tree.

5. The method of claim 1 wherein each node is adapted to be designated as active or inactive, wherein an active node in the family tree represents an individual who has registered with the system and an inactive node in the family tree represents an individual who has not registered with the system.

6. The method of claim 4 wherein each node is adapted to be designated as active or inactive, wherein an active node in the family tree represents an individual who has registered with the system and an inactive node in the family tree represents an individual who has not registered with the system.

7. The method of claim 1 wherein each node is associated with information pertaining to the individual that it represents.

8. The method of claim 1 wherein each node is associated with a unique identification.

9. The method of claim 1 wherein the nodes interact using the social networking features of the family tree.

10. The method of claim 5 wherein an individual with an active node in the family tree can interact with other living individuals with an active node in the family tree using the social networking features of the family tree.

11. The method of claim 10 wherein said interaction is selected from the group consisting of direct communication between individuals, sharing of data, receiving data, editing data, notification of data updates within a node, transfer of data to another node, and addition of data to another node.

12. The method of claim 1 wherein said linkage types are selected from the group comprising familial relationship types, social relationship types, biological relationship types and genetic relationship types.

13. The method of claim 1 wherein the relationship of a node to another node in the family tree can be represented by a series of linkages and nodes.

14. The method of claim 6 wherein a living-active node is associated with information pertaining to the living individual that it represents, and is associated with a tool selected from the group comprising communication tools, tools for editing the same node, and tools for constructing and editing the family tree.

15. The method of claim 6 wherein a living-active node allows the living individual that it represents to access means for constructing or editing a family tree, communicating with other nodes through the social networking features of the family tree, sending an invitation to individuals represented by inactive nodes to become active nodes, accepting invitations from other nodes, or granting permission to another individual to edit the family tree or carry out activities using the social networking features of the family tree.

16. The method of claim 6 wherein a living-active node is associated with a control panel accessible to the living individual that it represents, said control panel facilitating the editing of the same node, communication and interaction with other nodes, granting permissions, sending invitations, constructing the family tree, editing the family tree, or social networking features of the family tree.

17. The method of claim 6 wherein a living-inactive node is associated with information pertaining to the living individual that it represents.

18. The method of claim 6 wherein a living-inactive node is associated with a control panel accessible to living individuals in the system, said control panel facilitating the editing of the said living-inactive node.

19. The method of claim 6 wherein a living-inactive node is associated with a link permitting living individuals to send an invitation to the living individual represented by the said living-inactive node to register with the system and convert the said living-inactive node into a living-active node.

20. The method of claim 4 wherein a deceased node is associated with information, communication tools and database storage pertaining to the deceased individual that said deceased node represents and allows one or more living individuals to access means to view, add, edit or delete information pertaining to the deceased individual that said deceased node represents.

21. The method of claim 4 wherein a deceased node is associated with a control panel accessible to one or more living individuals, said control panel permitting the living individuals to independently add, edit or delete information for the deceased individual represented by the deceased node and to automatically record the identity of the contributor, whereby such contributions to the deceased node are viewable to a plurality of users using the social networking features of the family tree.

22. The method of claim 4 wherein a deceased node is associated with communication tools permitting living individuals to exchange information pertaining to the deceased individual that said deceased node represents.

23. The method of claim 1 wherein the linkage or series of linkages between a node with any other node in the family tree can be displayed.

24. The method of claim 5 wherein a living individual with an active node can view the linkage or series of linkages between said node and any other node in the family tree.

25. The method of claim 5 wherein the family tree can be edited by living individuals who are represented by an active node within the same family tree or another family tree in the system.

26. The method of claim 6 wherein a deceased-inactive node representing a deceased individual can be edited by one or more living individuals who are represented by an active node.

27. The method of claim 6 wherein a living-inactive node representing a living individual who has not registered with the system can be edited by one or more living individuals who are represented by an active node.

28. The method of claim 5 wherein an active node can be edited by the individual represented by said node or by one or more living individuals who are represented by an active node.

29. The method of claim 1 wherein the family tree can be edited by adding a new node to the family tree.

30. The method of claim 29 wherein a new node is added to the family tree by defining a linkage or a series of linkages between the newly added node and any existing node in the family tree.

31. The method of claim 29 wherein permission for a living individual to add a new node within the family tree is defined by the living individual's relationship to the node to be added as well as other living individuals in the family tree who will be affected by the addition of said new node.

32. The method claim 1 wherein the family tree is edited by changing the linkage type of an existing linkage in the family tree.

33. The method of claim 1 wherein the family tree is edited by deleting the linkage between a node and one or more nodes in the family tree.

34. The method of claim 25 wherein permission for a living individual who is represented by an active node to edit a linkage in the family tree is defined by living individuals who will be affected by the edit.

35. The method of claim 1 wherein the family tree is edited by adding, deleting or changing information associated with one or more nodes within the family tree.

36. The method of claim 1 wherein the family tree is edited by changing the node type.

37. The method of claim 6 wherein a living-active node for a living individual in the family tree can be converted to a living-inactive node.

38. The method of claim 6 wherein a living-active node for a living individual in the family tree can be converted to a deceased-inactive node once the living individual represented by said living-active node becomes deceased.

39. The method of claim 6 wherein a living-inactive node for a living individual in the family tree can be converted to a deceased-inactive node once the living individual represented by the said living-inactive node becomes deceased.

40. The method of claim 6 wherein a deceased-inactive node for a living individual in the family tree can be converted to a living-inactive node.

41. The method of claim 6 wherein a living-inactive node representing a living individual in the family tree can be converted to a living-active node.

42. The method of claim 25 wherein the permission for a living individual represented a living-active node to edit another node within the family tree is defined by the said individual's relationship to the node to be edited and said individual's relationship to all other individuals represented by living-active nodes within the family tree.

43. The method of claim 41 wherein a living individual represented by a living-active node can invite individuals represented by living-inactive nodes in the family tree to join the family tree and thereby change their living-inactive node into a living-active node.

44. The method of claim 41 wherein a living individual represented by a living-active node can identify living-inactive nodes within the family tree and send an invitation to the living individuals represented by the living-inactive nodes to register with the system and change the living-inactive node into a living-active node.

45. The method of claim 44 wherein said invitation is sent by means selected from the group comprising: email, internet, intranet, electronic means provided by the social networking features of the family tree, mail, telephone, and in person.

46. The method of claim 6 wherein when a living individual joins said family tree by registering with the system, said individual becomes represented as a living-active node within the family tree.

47. The method of claim 1 wherein a living individual joins a family tree by accepting an invitation sent by another living individual within the family tree.

48. The method of claim 1 wherein separate family trees can be merged into one.

49. The method of claim 48 wherein separate family trees can be merged into one by determining that one or more nodes from a first family tree overlap with one or more nodes from a second family tree and seeking permission to merge said family trees into one.

50. The method of claim 6 wherein a living individual with a living-active node can edit a first family tree by inviting living individuals with living-active nodes from a second family tree to join the first family tree and merge the family trees into one.

51. The method of claim 6 wherein a living-individual with a living-active node can edit a first family tree by adding an existing deceased-active node or a living-active node from a second family tree and merge the family trees into one.

52. The method of claim 6 wherein permission to edit a first family tree by merging with a second family tree is defined by living individuals who are represented by living-active nodes in both family trees who are affected.

53. The method of claim 1 wherein the family tree is displayed graphically to the user as a set of nodes connected by their associated linkages.

54. The method of claim 53 wherein the family tree is displayed to the user by setting a single node as the root of the family tree and displaying a set number of linkages of nodes radiating from the root and another part of the family tree is displayed to a user by resetting another node as the root.

55. The method of claim 54 wherein when a viewer navigates the family tree away from the original root, the path back to the original root is displayed.

56. The method of claim 1 wherein the family tree for any individual can be viewed by viewing the node representing said individual.

57. The method of claim 1 wherein the family tree can be viewed graphically or as a list of members.

58. A system for constructing a family tree whereby individual nodes in the family tree are linked as an online social network, wherein a plurality of users are accessible to the online social network, the system comprising:
i) website and database maintained by a server accessible online to said plurality of users;
ii) computer-implemented means for constructing a family tree whereby individual nodes in the family tree are linked as an online social network, each node representing a living or deceased member of the family tree, each node representing a member of the family tree who has registered with the system or who has not registered with the system, each node containing data pertaining to the individual that it represents, each node linked to one or more additional nodes in the family tree through one or more linkages with a defined linkage type, the linkage type representing the relationship type which exists between the individuals represented by each said node;
iii) computer implemented means for permitting living individuals to register with the system, be assigned a node associated with a unique identification, and modify said family tree and interact with other nodes in the family tree through said online social network; and
iv) computer implemented means whereby the nodes in the family tree interact using the social networking features of the family tree.

59. A computer program product comprising a memory having stored therein computer-executable instructions that when executed by a computer carry out the method of claim 1.
